(19) United States
(12) Patent Application Publication
(10) Pub. No.: US 2013/0049332 A1
(43) Pub. Date: Feb. 28, 2013

(54) Decoy Cart

(71) Applicant: Thomas Chris Evensen, Choteau, MT (US)

(72) Inventor: Thomas Chris Evensen, Choteau, MT (US)

(21) Appl. No.: 13/592,311

(22) Filed: Aug. 22, 2012

Related U.S. Application Data
(60) Provisional application No. 61/575,372, filed on Aug. 22, 2011.

(51) Int. Cl. B62B 1/12

(52) U.S. Cl. 280/651

(57) ABSTRACT

The Decoy Cart is an improved economic, stable, lightweight, two-wheeled hand cart for the transportation of a large number of bulky waterfowl decoys and associated hunting gear into the field over rough terrain. The cart is easily foldable for compact storage, portability, field concealment, and shipping. The cart also functions in stretcher fashion to carry the load, with or without the wheels, when terrain conditions render wheels ineffective, or for when the loaded cart needs to be lifted over obstacles en route, or into or out of a vehicle or storage area.

### BACKGROUND OF THE INVENTION

This invention relates, in general, to an collapsible, wheeled cart, and, in particular, to a two wheeled cart take can be collapsed for transport and storage, and used to transport decoys, rifles, game and other items related to hunting.

Field or shore hunting for waterfowl requires a large number of decoys and associated equipment. Decoys are bulky. Transporting a large number of decoys and associated hunting equipment a significant distance to and from the hunting field is very difficult. Furthermore, today's waterfowl are more conditioned and wary then previous generations. In many cases, to successfully hunt today's waterfowl requires not only a great number of decoys, but a great number of ultra-realistic full-body decoys. These full-body decoys are very voluminous and therefore transportation of a number of these bulky decoys poses an even a greater difficulty than encountered in the past with more compact silhouette and shell decoys. The problems associated with waterfowl hunting and the need to transport decoys and associated gear are old and well known. As a result, there have been a number decoy carts of designed and a variety of utility, hunting, and game carts employed for decoy transportation with mixed success.

Previously hunters have used a wide variety of vehicles such as deer carts, wheel barrows, trash cans, 3-wheel running carts, “flat bed” carts, folding garden carts, children's wagons and various homemade carts. A whole host of wheeled contrivances have been used, mostly with unsatisfactory results. Blog sites commenting on the topic of decoy carts illustrate the frustration that exists with existing carts, and a search for a satisfactory solution to the need for transporting bulking decoys and waterfowl gear over rough terrain.

### DESCRIPTION OF THE PRIOR ART

In the prior art various types of collapsible carts for transporting game and similar items have been proposed. The following prior art describes previous devices related to the instant invention.

U.S. Pat. No. 3,222,100 issued Dec. 7, 1965, to Lindzy for a Personnel or Game Carrier. Lindzy shows a game cart frame that disconnects at the middle of the cart to allow the frame to be longitudinally folded via the pivoted wheel supports, and has detachable wheels. This allows the cart to be reduced to a low profile configuration for transport and storage.

U.S. Pat. No. 3,860,254 issued Jan. 14, 1975, to Wegener for a Foldable Packer. Wegener shows a cart which folds in the longitudinal direction. The frame is pivoted at the axle, and has upper braces to hold it in the unfolded position. The upper braces are pivoted in the middle to allow folding, and are locked in the unfolded position by a sliding sleeve which covers the pivot joints. This sliding sleeve is much different than the slider in the instant invention.

U.S. Pat. No. 5,785,334 issued Jul. 28, 1998, to Robinson for a Bicycle Towable Collapsible Cart. Robinson shows a folding cart with a frame mounted flexible container that is similar to the flexible container of the instant invention.

U.S. Pat. No. 7,032,921 issued Apr. 25, 2006, to Swanner for a Cart to Transport Equipment or the Like. Swanner shows a cart which partially folds in the longitudinal direction and has detachable wheels.

U.S. Pat. No. 7,172,207 issued Feb. 6, 2007, to Henry for a Collapsible Cart. Henry shows a cart that folds in the transverse direction. This is accomplished by the use of telescoping uprights on both sides of the frame.

### SUMMARY OF THE INVENTION

The instant invention is directed to the need for an improved economic, stable, lightweight, two-wheeled hand cart for the transportation of a large number of bulky waterfowl decoys and associated hunting gear into the field over rough terrain. The cart is easily foldable for compact storage, portability, field concealment, and shipping. The cart also functions in stretcher fashion to carry the load, with or without the wheels, when terrain conditions render wheels ineffective, or for when the loaded cart needs to be lifted over obstacles en route, or into or out of a vehicle or storage area.

It is an object of the present invention to provide a new and improved folding hand cart for transporting large numbers of bulky decoys and game across rough terrain by two people.

It is an object of the present invention to provide a new and improved cart with removable wheels which can be easily and quickly folded to a smaller profile for transport and storage.

It is an object of the present invention to provide a new and improved cart with a flexible container to hold the decoys during transport, and to prevent them from spilling out.

It is an object of the present invention to provide a new and improved cart with multiple gun scabbards for hands free transport of guns.

It is an object of the present invention to provide a new and improved cart with pockets to contain ammunition and other equipment for transport.

It is, an object of the present invention to provide a new and improved cart with load stability provided by a low cart height to wheel base width ratio and a low loaded center of gravity.

It is an object of the present invention to provide a new and improved cart having ease of rollability by the use of large diameter tires.

It is an object of the present invention to provide a new and improved cart that is lightweight by the use of a minimal structure, efficient truss frame design, and construction with lightweight tubular members.

It is an object of the present invention to provide a new and improved cart having economic construction by efficient design, ready availability of materials, and with minimum artisan technical skill.

It is an object of the present invention to provide a new and improved cart having ease of extension or folding by manual insertion or removal of a few self securing fasteners without requiring the use of tools.

It is an object of the present invention to provide a new and improved cart which is readily broken down into its component members for compact shipping.

It is an object of the present invention to provide a new and improved cart with increased strength provided by the overall design arrangement, a central frame that bears all the cart forces and moments, and the strength of materials utilized.

It is an object of the present invention to provide a new and improved cart which can used to carry a load stretcher fashion.

These and other objects and advantages of the present invention will be fully apparent from the following description, when taken in connection with the annexed drawings.

### BRIEF DESCRIPTION OF THE DRAWINGS

FIG. 1 is an overall view of the decoy cart.

FIG. 2 is a view of the central frame.

FIG. 3a-3h show alternative central frame geometries.

FIG. 4 is a view of the slider.

FIG. 5 is a view of the frame.

FIG. 6a-6f are views of alternative frame geometries.

FIG. 7 is a view of the flexible container.

FIG. 8 is a view of an alternate flexible container.

### DESCRIPTION OF THE PREFERRED EMBODIMENT

The preferred embodiment herein described is not intended to be exhaustive or to limit the invention to the precise form disclosed. It is chosen and described to best explain the invention so that others, skilled in the art to which the invention pertains, might utilize its teachings.

Referring now to the drawings in greater detail, FIG. 1 shows an overall view of the cart 1. A central frame 2 is located in the center of the cart 1. Extending fore and aft of the central frame 2 are two identical frame sections 3. Each frame section 3 is pivotally mounted to the lower end of the central frame 2, and also pivotally mounted to a slider 4, which is slidably mounted near the upper end of the central frame 2. When the slider 4 is fixed in the upper position, the frame sections 3 are extended into their operational configuration. When the slider 4 is lowered to a low position on the central frame 2, the frame sections 3 fold into a storage position. Wheels 5 are rotatably and removably mounted to the lower end of the central frame 2. Utility straps 6 are mounted to the top end of the central frame 2. A flexible container 7 is mounted on the frame sections 3.

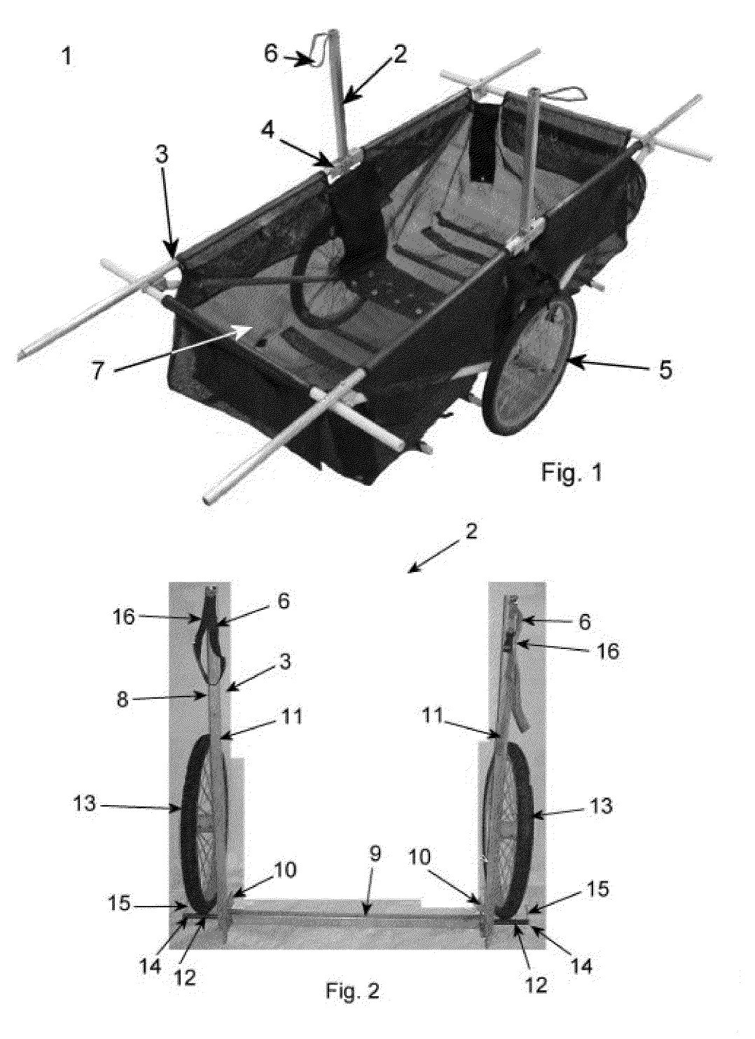

FIG. 2 shows the details of the central frame 2. In the preferred embodiment, the central frame 2 is a square U-shaped tubular frame 8. The tubular frame 8 has a transverse lower horizontal member 9. Parallel gusset plates 10 are rigidly attached to each end of the lower horizontal frame member 9 by welding, fasteners, or other known connection means. Parallel upright frame members 11 are rigidly attached to the transverse lower horizontal member 9 by welding, fasteners, or other known connection means. An axle 12 is mounted on the central frame 2 by passing through the center of the parallel upright frame members 11. The axle 12 bears on the holes in parallel upright frame members 11. The axle 12 might also take the form of two stub axles (not shown) which extend only part way into the transverse lower horizontal member 9. A pair of wheels 13 are pivotally and removably mounted to the opposite ends of the axle 12. The ends of the axles 12 are provided with holes 14, through which fasteners 15 are connected to keep the wheels 13 on the axle 12. The fasteners 15 are removed from the holes 14 when the wheels are removed for storage or transport. A plurality of adjustable utility straps 6 are mounted to the tops of the upright members 11 and are used to secure a variety of loads (not shown) to the cart 1. The utility straps 6 can be provided with couplers 16 for quick connection and disconnection. The utility straps 6 may also be provided with hook and loop type fasteners (not shown) such as Velcro™ hook and loop fasteners.

FIGS. 3a-3h show alternative geometries for constructing the central frame 2. FIG. 3a shows the central frame with a square U-shaped geometry, which is described above. FIG. 3b shows a central frame with an inverted square U-shaped geometry. In this variant, the lower horizontal frame member 9 has been relocated to the top of the upright members 11. FIG. 3c shows a central frame with a bent U-shaped geometry. In this variant the transverse lower horizontal member 9 and the upright members 11 are constructed from a single tubular member 17 which has been bent into a U-shape. FIG. 3d shows a central frame with an inverted bent U-shaped geometry. FIG. 3e shows a central frame with a truss geometry. In this variant, the transverse lower horizontal member 9 has been replaced with two truss members 18. FIG. 3f shows a central frame with a half-truss geometry. In this variant, two half truss members 19 have been connected between the transverse lower horizontal member 9 and the upright members 11. FIG. 3g shows a central frame with a solid geometry. In this variant, the transverse lower horizontal member 9 and the upright members 11 have been replaced with a solid sheet of material 20. FIG. 3h shows a central frame with an H-shaped geometry. In this variant, the transverse lower horizontal member 9 has been relocated to the center of the upright members 11.

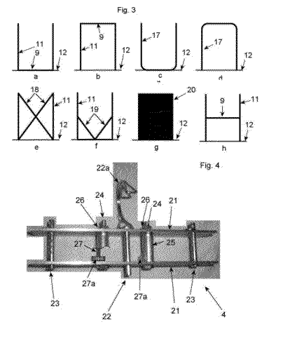

FIG. 4 shows one of the sliders 4. Each slider 4 is comprised of two parallel plates 21. Each of the plates 21 has several openings. The central openings are provided for fasteners 22 which connects the sliders 4 to the uptight members 11. Keepers 22a are provided on the end of each fastener 22 which loops around the upright members and connects to the opposite end of fastener 22 to holder the fastener 22 in place. The end openings are provided for fasteners 23 which pivotally connect the slider 4 to the frame sections 3. The upper intermediate openings are provided for bolts 24, which extend through one plate 21, through spacers 25, and then the second plate 21, the whole of which being secured with nuts 26. Other types of fasteners may be used instead of bolts 24 and nuts 26. The lower intermediate openings are provided for bolts 27, which extend through plates 21 and on which rollers 27a are mounted. When the sliders 4 are mounted on the upright members, the rollers 27a provide for smooth movement between the operational and storage positions of the frame sections 3.

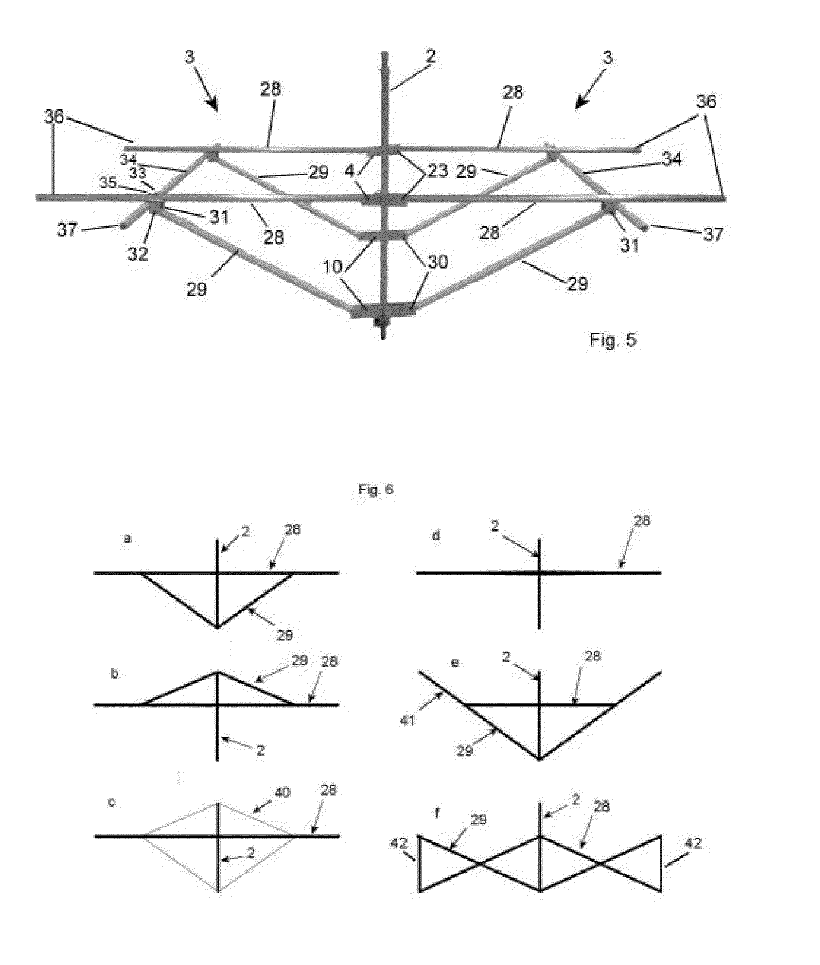

FIG. 5 shows details of the frame sections 3. The frame sections 3 are symmetrically mounted fore and aft of the central frame 2. The components of the frame sections 3 are preferably made of light weight tubular material, such as aluminum tubing. The upper frame members 28 are pivotally connected to the sliders 4 by fasteners 23. The lower frame members 29 are pivotally connected to the gusset plates 10 by fasteners 30. The opposite end of the lower frame members 29 are pivotally connected to brackets 31 by fasteners 32. The brackets 31 are connected to the upper frame members 28 by fasteners 33. Cross members 34 extend transversely between the brackets 31, and are connected to either the brackets 31 or the upper frame members 28 by fasteners 35. Alternatively, the lower frame members 29 and the cross member 34 may be constructed as a single U-shaped frame member (not shown). The end of the upper frame members 28 opposite the connection to the sliders 4 extend beyond the connection with the lower frame members 29 to form handles 36. The cross members 34 may extend beyond the upper frame members 28 to provide additional handles 37. The flexible container 7 is supported by upper frame members 28, cross members 34 and the transverse lower horizontal member 9.

FIGS. 6a-6z show frame geometry variations. FIG. 6a shows the truss geometry of the preferred embodiment described previously. FIG. 6b shows a King Post truss geometry in which the lower frame members 29 are positioned above the upper frame members 28. FIG. 6c shows a cabled stayed truss geometry in which the lower frame members 29 are removed and replace with cable stays 40. FIG. 6d shows a cantilevered truss geometry in which the lower frame members 29 are removed, and the upper frame members 28 are made thicker near the central frame 2. FIG. 6e shows an alternative truss geometry in which the upper frame members 28 end at their connection with the lower frame members 29, and the lower frame members 29 extend beyond their connection with the upper frame members 28 to form handles 41. FIG. 6f shows a scissors truss geometry in which upper frame members 28 angle downward to cross lower frame members 29. The upper frame members 28 and the lower frame members 29 are pivotally connected at their center points. The ends of the upper frame members 28 and the lower frame members 29 are pivotally connected to end uprights 42.

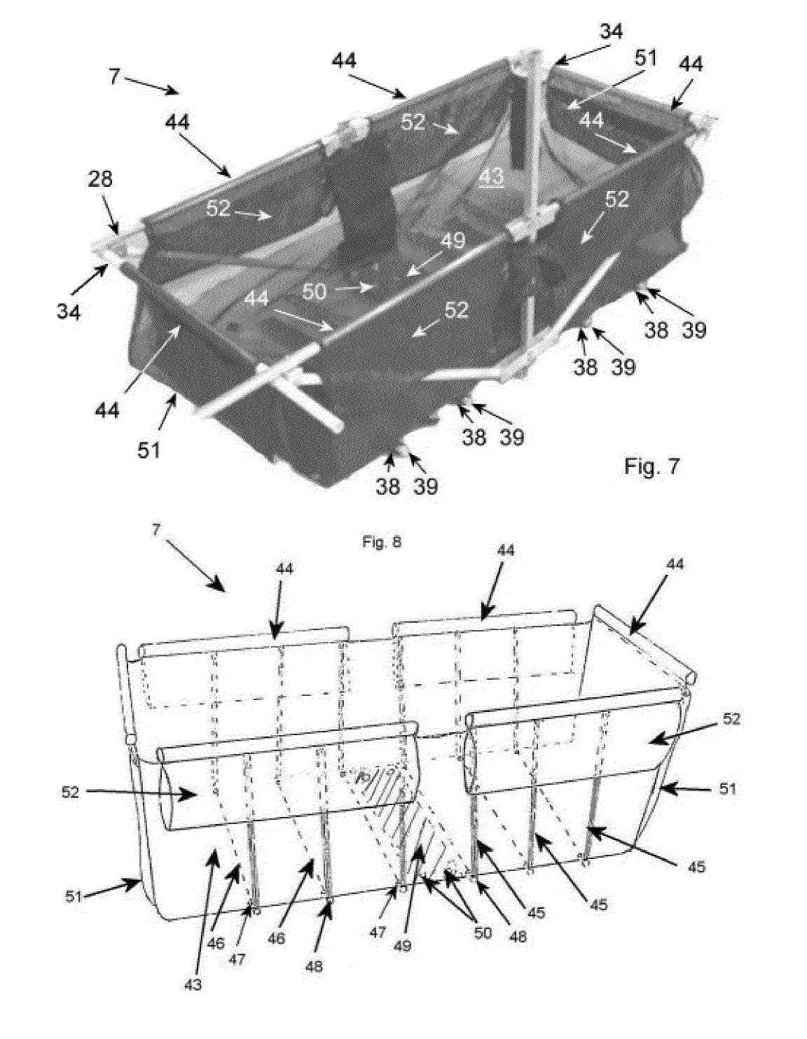

FIG. 7 shows the construction of the flexible container 7. The flexible container 7 is suspended from upper frame members 28 and cross members 34, and rests on the transverse lower horizontal member 9. The body 43 of the flexible container 7 is constructed of a strong and light material such as nylon, and may be a solid or a net-like fabric. The body 43 is provided with six suspension tubes 44 through which the upper frame members 28 and cross members 34 are inserted. Four external tubes 38 are provided on the bottom of the bag 7. Tube inserts 39 are inserted into the external tubes 38 to provide support for the load. Tube inserts 39 are made of a light weight material such as PVC pipe or aluminum tubing. The external tubes 38 may extend across the width of the bag or may be formed as short sections on each side of the bag. More than four external tubes 38 and tube inserts 39 may be used if desired. A wear liner 49 is attached to the bottom of the body 43 to resist wear from the transverse lower horizontal member 9. Grommets 50 are provided at the ends of the wear liner 49 for the purpose of fastening the body 43 to the transverse lower horizontal member 9. A cord (not shown) or other fastening means can be passed through the grommets 50 to attach the body 43 to the transverse lower horizontal member 9. End pockets 51 are attached to the ends of the body 43 by sewing or other suitable fasteners. The top openings of the pockets 51 are sealed with hook and loop type fasteners (not shown) such as Velcro™ hook and loop fasteners, or other suitable fasteners. Scabbards 52 are suspended from the longitudinal suspension tubes 44. The scabbards 52 are used for carrying guns and other hunting equipment. The openings of the scabbard may be sealed with hook and loop type fasteners (not shown) such as Velcro™ hook and loop fasteners, or other suitable fasteners.

FIG. 8 shows a second embodiment of the flexible bag 7. Extending downward from the suspension tubes 44 are twelve support straps 45, six on each side. The support straps 45 may be sewn or otherwise fastened to the body 43. The lower ends of the support straps 45 are connected to cross supports 46 by fasteners 47. The cross supports 46 pass through grommets 48 in the bottom of the body 43 and serve to support the weight of the decoys, game and other items carried in the flexible container 7. A third embodiment of the flexible bag 7 uses an internal frame (not shown) that lays inside on the bottom the flexible bag 7. The internal frame is made of a light weight material such as PVC pipe or aluminum tubing.

Although the Decoy Cart and the method of using the same according to the present invention has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. A collapsible cart comprising:
a central frame comprising a transverse lower horizontal member, and two vertical members connected near the ends of said transverse lower horizontal member;
wheels removably attached to the ends of said lower horizontal member;
a front frame section, comprising two front lower longitudinal frame members, two front upper longitudinal frame members, and a front transverse frame member;
one end of said two front lower longitudinal frame members being pivotally connected to said transverse lower horizontal member, the opposite ends of the two front lower longitudinal frame members being connected to the ends of said front transverse frame member;
one end of said two front upper longitudinal frame members being pivotally and slidably connected to the two vertical members by two pivotal and slidable connections, the opposite ends of said two front upper longitudinal frame members being pivotally connected near the connections of said two front lower longitudinal frame members and said front transverse frame member;
a rear frame section, comprising two rear lower longitudinal frame members, two rear upper longitudinal frame members, and a rear transverse frame member;
one end of said two rear lower longitudinal frame members being pivotally connected to said transverse lower horizontal member, the opposite ends of the two rear lower longitudinal frame members being connected to the ends of said rear transverse frame member;
one end of said two rear upper longitudinal frame members being pivotally and slidably connected to the two vertical members by said two pivotal and slidable connections, the opposite ends of said two rear upper longitudinal frame members being pivotally connected near the connections of said two rear lower longitudinal frame members and said rear transverse frame member;
a container situated within and connected to said front and rear frame sections;
wherein when said two pivotal and slidable connections are moved to the bottom of said two vertical members, the front and rear frame members fold up against the central frame, and when said pivotal and slidable connections are moved to the top of said vertical members, the front and rear frame members unfold away from the central frame.

2. The collapsible cart as claimed in claim 1, wherein said front and rear upper longitudinal frame members extend beyond said pivotal connection with said front and rear lower longitudinal frame members to form handles.

3. The collapsible cart as claimed in claim 1, wherein said container is made of a flexible material.

4. The collapsible cart as claimed in claim 1, wherein said two pivotal and slidable connections each comprise:
two parallel plates having openings near the ends, middle openings, and intermediate openings between said middle openings and said openings near the ends;
a connection pin which extends through said middle openings and through an opening in said vertical member;
a keeper connected to said connection pin to prevent inadvertent disconnection;
pivot pins which extend through said openings near the ends to which said front and rear upper horizontal members are pivotally connected;
axle pins extending through said intermediate openings, rollers being mounted on said axle pins between said two parallel plates, said rollers engaging the vertical member to provide smooth movement when said pivotal and slidable connections move along said vertical members.

5. The collapsible cart as claimed in claim 1, wherein said container comprises scabbards connected to the longitudinal outsides of said container, said scabbards being suitable to hold rifles and other hunting equipment.

6. The collapsible cart as claimed in claim 1, wherein said container comprises pockets connected to the transverse outsides of said container.

7. The collapsible cart as claimed in claim 1, wherein said two lower longitudinal frame members and said rear transverse frame member are formed as a single U-shaped member.

8. The collapsible cart as claimed in claim 1, wherein said central frame further comprises cross bracing connecting said vertical members.

9. A collapsible cart comprising:
a central frame member and two extendable frame members;
said extendable frame members being pivotally connected at their lower ends to the lower end of said central frame member;
and said extendable frame members being pivotally and slidably connected at their upper ends to the upper end of said central frame member;
wheels attached to said central frame member;
a container connected to said extendable frame members;
wherein when the slidable connection at the upper end is moved towards the lower end, the cart collapses, and when the slidable connection is moved towards the upper end the cart opens.
